(19) United States
(12) Patent Application Publication
(10) Pub. No.: US 2018/0238513 A1
(43) Pub. Date: Aug. 23, 2018

(54) Laminated Light-Transmitting Panel For A Vehicle With Embedded Light Sources

(71) Applicant: Pacific Insight Electronics Corp., Nelson (CA)

(72) Inventors: Erik Measel, St. Clair, MI (US); Lorenzo F. Manderville, Grand Blanc, MI (US); Michael Medvec, Saline, MI (US); Paul Gresser, Saline, MI (US)

(21) Appl. No.: 15/953,418

(22) Filed: Apr. 14, 2018

Related U.S. Application Data
(63) Continuation of application No. PCT/US2016/057186, filed on Oct. 14, 2016.
(60) Provisional application No. 62/241,607, filed on Oct. 14, 2015.

(51) Int. Cl. F21S 43/14; B32B 7/12; B32B 17/10; B32B 27/36; H05B 33/08; B60Q 3/70; B60Q 3/208; B60Q 3/80

(52) U.S. Cl. CPC F21S 43/14; B32B 7/12; B32B 17/10541; B32B 27/365; H05B 33/0857; B60Q 1/44; B60Q 3/208; B60Q 3/80; B32B 2250/03; B32B 2457/00; B32B 2605/00; B60Q 3/70

(57) ABSTRACT

A laminated light-transmitting panel for installation in a vehicle comprises a first layer that is a light transmitting structural element, a second layer that is disposed opposite to the first layer, and a third layer disposed between the first and second layers. The third layer comprises a plurality of light sources arranged to serve both functional and aesthetic purposed and an electrical circuit connected to each of the plurality of light sources to power and to ground. At least one of the plurality of light sources can be controlled independently from the other ones of the plurality of light sources.

### CROSS-REFERENCE TO RELATED APPLICATIONS

This application is a continuation of and claims priority benefits from International Application No. PCT/US2016/057186 filed Oct. 14, 2016, entitled “Laminated Light-Transmitting Panel For A Vehicle With Embedded Light Sources” which claims priority benefits from U.S. Provisional Patent Application No. 62/241,607 filed Oct. 14, 2015 entitled “Laminated Light-Transmitting Panel For A Vehicle With Embedded Light Sources”. This application is also related and claims priority to the '607 application. The '186 and '607 applications are hereby incorporated by reference herein in their entireties.

### FIELD OF THE INVENTION

The present application relates to laminated light-transmitting panel for a vehicle with embedded light sources and a method of controlling the light sources. More particularly, the method comprises dynamic timing and color control for illuminating the light sources.

### BACKGROUND OF THE INVENTION

There is a trend in vehicle design to incorporate larger glass panels in the roof and/or the sides as windows. For interior vehicle lighting, a centrally located dome light is often employed to provide general cabin lighting. When a large glass panel is installed in a vehicle roof panel, the traditional central location for a conventional dome light is not available. This results in ambient lighting being located in other locations which can be less than optimal. As glass panels get larger, finding suitable locations to install interior lighting becomes more challenging. Some have tried to solve this problem by using edge lighting around the perimeter of a glass panel or with light sources installed in side pillars in the body frame. U.S. Patent Application Publication No. 2015/0151675 A1 (the '675 publication) discloses illuminating the passenger compartment using a set of light emitting diodes (“LED”s) disposed between sheets in a laminated glass panel. However, the '675 publication limits the glass panel to having a maximum light transmission (LT) factor of at most 50%, with the number and power of the diodes being selected in order to provide useful lighting without causing detrimental overheating for the components of the glass panel.

Another trend in the automotive industry is the adoption of LED light sources as substitutes for more conventional incandescent light bulbs. LED lighting uses less power, generates less heat, and can be installed in locations where incandescent light bulbs could not be installed, such as between sheets of laminated glass. In addition, LED light sources offer more capabilities beyond simply being turned on, off and dimmed. LED light sources can be designed to allow color changing, so the vehicle operator can customize the lighting color or the lighting can be pre-programed with different lighting patterns for different operating conditions. In the past, vehicle lighting was used primarily for functional purposes, for example, to assist the driver and passengers to enter a vehicle when it is dark, to better see the controls, or to read maps. Combining functional uses with aesthetic features remains largely unexplored. However, improving the user experience and aesthetics are both now receiving more attention as these factors become important for product differentiation in the marketing of vehicles and instilling pride of ownership for the purchasers. In fact, research has confirmed that lighting can enhance the driver's visual sense and the mood of accompanying passengers.

LED light fixtures have been developed for other applications such as signage, furniture decoration and household lighting. U.S. Pat. No. 7,604,377 (the '377 patent), discloses an LED lighting apparatus with transparent flexible circuit structure. The '377 patent discusses a transparent electrically conductive tape that can be used to form the electrical circuit that delivers power to the LEDs.

In the competitive automotive market, there is a competitive advantage to be gained by adding multi-functionality, adding more value, making vehicles more desirable, improving the driving experience, and increasing brand value, by adapting and applying new lighting technologies to vehicles.

### SUMMARY OF THE INVENTION

A laminated light-transmitting panel can be installed in a vehicle. The laminated panel can comprise a first layer that is a light transmitting structural element, a second layer that is disposed opposite to the first layer, and/or a third layer disposed between the first and second layers, with these three layers laminated into a unitary panel. Depending upon the size of the panel, the thickness of the layers, the material chosen for each layer, and/or the structural strength specified for a particular panel, the second layer and/or the third layer can be formed as additional structural elements, and/or the unitary panel can comprise more layers of structural elements. The third layer can comprise a plurality of light sources arranged to serve both functional and aesthetic purposes and/or an electrical circuit connected to the plurality of light sources, wherein at least one of the plurality of light sources can be controlled independently from the other ones of said plurality of light sources. In some embodiments, the third layer can be integrated with one of the other layers, for example by printing the electrical circuit onto another layer with the plurality of light sources connected to the electrical circuit before the three layers are formed into a laminated unitary panel.

While the adoption of LED light sources in vehicles is spreading, the light sources discussed can be selected from different types of light sources that are also alternatives to traditional incandescent light bulbs. The light sources can be of the same type or the light sources can comprise different types of alternative lighting sources in the same panel. For example, at least some of the light sources can be LEDs, including organic light emitting diodes or RGB LEDs. In some embodiments, the light sources comprise light conductors that conduct light from a light source through a conduit that gives off light, such as conductor can be used to produce a lighted image or outline of a logo for the vehicle or the manufacturer's brand. Other light sources can include lasers and/or LCD screens.

Glass and plastic are examples of materials that can be used to manufacture structural elements. In some embodiments, at least one of the first and second layers is made from glass. Both first and second layers can be made from glass. However, as panels get larger, the weight of the panel becomes a design factor as reducing the overall vehicle weight reduces fuel consumption and improves driving performance. Plastic can provide the same strength as glass, while weighing less. Thus, in some embodiments, at least one of the first and second layers is made from a plastic material.

In some embodiments, the second layer can be a coating or an adhesive film that insulates and protects the third layer without adding significant structural strength. This approach can be advantageous as all customers might not order a vehicle with lighting embedded in the panel. To allow manufacturing flexibility, the laminated panels can be manufactured in at least two steps. In a first step, the structural elements are laminated. In a second step, the third layer with the electrical circuit is placed on the surface of the laminated structural elements and then the second layer is applied on top of the third layer. In some embodiments, the electrical circuit and plurality of light sources can be configured according to a menu of customer specifications facilitating a degree of customization. In other embodiments, the second step can be skipped if the customer does not select embedded lighting. In this way, the same structural laminated panel can be used for the same model vehicle regardless of whether the customer orders embedded lighting. In some embodiments, the second step can be applied to existing vehicle panels to add lighting to a light-transmitting panel of a vehicle that was not manufactured with this feature. That is, the disclosed lighting system can be added at retail dealerships in response to a customer's selected options for panel lighting and/or it can be installed as an after-market product to vehicle windows and clear roof panels.

In some embodiments, the laminated light-transmitting panel(s) can be installed as a roof panel, a side window, a rear window and/or a front windscreen. When installed as a front windscreen, the light sources can be located such that they do not obscure the driver's view of the surrounding environment. In some embodiments, the light sources are still visible to assist the driver by displaying useful information. In some embodiments, the light sources have a reflector and/or shield so that the light from a light source is only visible from one side of the panel. Depending upon the location where the panel is installed, the panel can be clear, color tinted, frosted, or translucent. In some embodiments, the panel allows visibility through the panel in only one direction, for example so-called “one-way” or “mirrored” glass. In some embodiments, portions of or the entire second layer can be opaque, so that light transmission from some or all of the light sources is only out from the panel through the first layer. For example, the light sources can be used to display flashing lights on an emergency vehicle and be shielded so that they are visible from outside the vehicle but not from inside the vehicle. For police cars, ambulances and other emergency vehicles this can result in a more aerodynamic vehicle design because it can obviate the need for mounting rooftop lights or other externally mounted lights. An added advantage for unmarked police vehicles is that when the lights are not activated, this type of lighting can be less visible, making an unmarked police car stealthier. In a civilian vehicle, lights mounted in this way could also be used for auxiliary lighting, for example for off road vehicles.

In some preferred embodiments, the electrical circuit is configured so that at least one of the plurality of light sources can be controlled independently from the other ones of the plurality of light sources. An electronic controller can be programmed to control timing for when each individual light source is energized and for controlling the length of time that each light source is energized. By controlling the time and duration that each light source is energized, it is possible to achieve lighting effects from the plurality of light sources that is suggestive of motion. Other effects can also be used to indicate information to the vehicle driver and passengers. For example, if a hazard condition is detected, light sources that are RGB LEDs can switch to a warning color such as red or orange and/or they can begin to flash on and off Examples of hazard conditions include, but are not limited to, detecting an approaching object in a blind spot, detecting that the distance to a forward object is decreasing too quickly, and/or detecting lane departure without activation of a tum signal.

In the third layer, the electrical circuit can comprise an electrically conductive film, for example, a film made at least in part from indium tin oxide. The plurality of light sources can be attached to the electrically conductive film so that the film and light sources are formed as a sheet that is laid between the first and second layers during the manufacturing process. While the electrical circuit is part of a third layer that is disposed between the first and second layers the electrical circuit can be printed onto one of the first and second layers. In some embodiments, the electrical circuit is made from electrically conductive silicone, which can also be optically clear.

### BRIEF DESCRIPTION OF THE DRAWINGS

FIG. 1 illustrates a plan view of a laminated light-transmitting panel showing light sources embedded in the panel by being installed between two layers of the laminated light-transmitting panel.

FIG. 2 illustrates a plan view of a second embodiment of a light-transmitting panel showing light sources embedded in the panel by being installed between two layers of the laminated light-transmitting panel.

FIG. 3 is an exploded view of a laminated light-transmitting panel showing the different layers of the laminated light transmitting panel; the light assembly is shown as a middle layer.

FIG. 4 is a view of a rear window panel with embedded light sources.

FIG. 5 is a view of a windscreen with embedded light sources.

FIG. 6 is a view of a side window with embedded light sources.

FIG. 7 is a cross section view of a laminated light transmitting panel with one layer being a non-structural coating or thin film.

FIG. 8 is a process flow diagram showing steps in a first embodiment of a manufacturing process for a laminated light-transmitting panel with embedded lights.

FIG. 9 is a process flow diagram showing steps in a second embodiment of a manufacturing process for a laminated light-transmitting panel with embedded lights.

### DETAILED DESCRIPTION OF ILLUSTRATIVE EMBODIMENT(S)

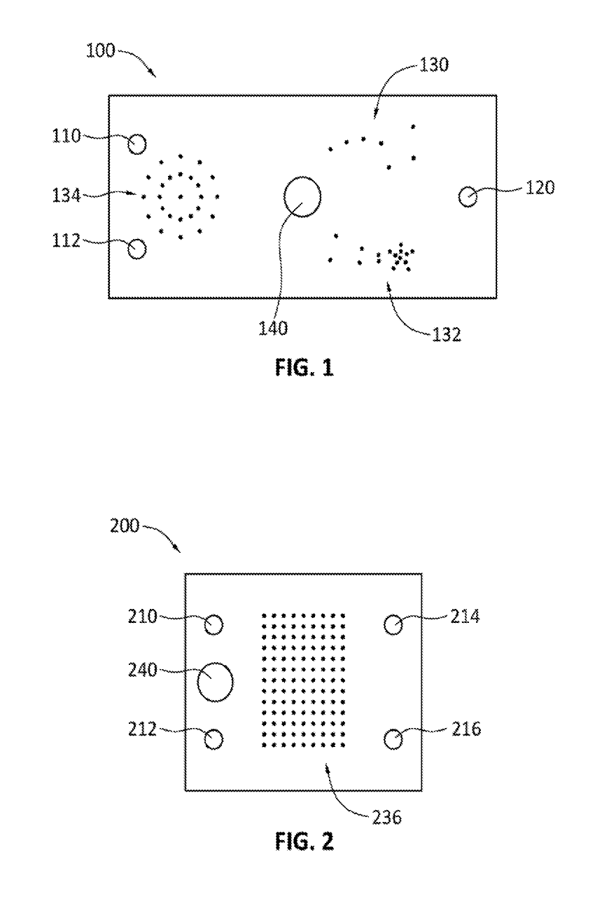

FIG. 1 is a plan view of laminated light-transmitting panel 100, which is of a size suitable for installation in the roof of a vehicle either as a movable panel for a sunroof or a fixed roof panel. Panels can be sized to suit the design of the vehicle. The elongated shape of panel 100 could be associated with a fixed roof panel, sometimes known as a “panoramic” panel because it is larger than more common glass panels mounted in a roof panel. A panoramic panel allows passengers in the second or third row to also enjoy the view and the sunlight through a clear glass or plastic panel. The light sources embedded in the panel can be of one type or several types. By way of example, different types of lights sources are described with respect to panel 100. In FIG. 1 panel 100 is shown with the front of the vehicle closer to the left edge of panel 100 with the sides of the vehicle associated with the top and bottom edges.

Lights 110 and 112 are spotlights that can be positioned above the driver and front seat passenger, respectively, and be turned on to give a focused beam suited for reading maps or other reading material. In some embodiments, the light sources for lights 110 and 112 can each be a single light source or a cluster of white LEDs with a reflector shaped to focus the light into a beam. Alternatively, the light sources could be RGB LEDs so that they can be controlled to change color for example to deliver white light for reading and other colors when illuminated or flashed as a warning light to indicate a detected hazard. Lights 110 and 112 can be controlled through different electrical circuits so that each light can be controlled independently. In other arrangements, more spotlights can be incorporated into the layer of embedded lights to provide lighting for persons sitting in a second or third row of the vehicle, or in the case of a bus, for each passenger seat.

Light source 120 is another light source that is designed to give a more diffused general lighting to the vehicle cabin or to a storage area for a hatchback. The light source can be the same type of light source that is installed in other parts of the panel or it can be different. For example, lights 110, 112 and 120 can all be monochromatic LEDs, OLEDs, and/or polychromatic RGB LEDs. To produce a more diffused light source, light 120 can employ reflectors and/or a lens shaped to produce a more diffused light source that illuminates a general area instead of a focused beam.

In some embodiments, each light source operates independently from the other light sources and has its own electrical circuit. A transceiver receives command signals and sends signals to control the light sources associated with each electrical circuit. For example, an LED lighting system can comprise a master controller that generates a command signal that is sent to a transceiver associated with an LED light source; the transceiver sends the command signal to a slave microprocessor that controls the current delivered to the LED light source to produce the desired light properties which can include, by way of illustrative example, light intensity and color, depending upon the type of light source. For an RGB LED, the slave microprocessor controls the amount of current sent to each colored LED to achieve the desired color by blending the colors of the individually colored LEDs.

FIG. 1 also shows light sources that can be arranged in patterns indicated by reference numbers 130, 132 and 134. These clusters of light sources can be both functional and aesthetic lighting elements. Functional aspects include general lighting for the vehicle interior. Studies support the theory that lighting color choices can affect the mood and alertness of the passengers. Accordingly, in some embodiments, colors in light cluster 134 can be chosen to help with alertness. In other or the same embodiments, colors in light clusters 130 and 132 can be chosen to have a relaxing effect for passengers sitting in other seating rows. In some embodiments, brightness can also be controlled to assist with passenger comfort.

In some embodiments, certain lights, such as those shown in cluster 130, can be positioned to have an aesthetic effect. For example, the lights in cluster 130 as shown in FIG. 1 are positioned to exhibit a shape that is suggestive of the stars in the “big dipper”.

In some embodiments, the lights in cluster 130 can be an array in a single electrical circuit so that these light sources are controlled as a group with one electrical circuit. In other embodiments, the lights in cluster 130 can be controlled individually by separate electrical circuits, or in subgroups with an intermediate number of electrical circuits. If there is more than one electrical circuit for a cluster, at least some of the light sources can be illuminated independently, for example, sequentially, or with a delay for illuminating each light until all are illuminated (if each light has its own electrical circuit). Many variations are possible to create a dynamic lighting effect that is distinctive for the vehicle. To illustrate an alternative arrangement, the lights in cluster 132 are positioned in a shape that is suggestive of a comet or a shooting star. Again, the light sources in cluster 132 can be controlled as a group, in subgroups, or individually, as allowed by the design of the lighting system and the number of electrical circuits. For example, with one lighting pattern, the head of the comet could be a subgroup that can be illuminated continuously, while the light sources in the “tail” portion can be illuminated intermittently and timed to create an effect suggestive of motion.

The light source in cluster 134 are arranged in a radial pattern, which could be suitable for providing a diffused light for general cabin lighting that could be activated automatically when passengers are entering or exiting the vehicle. The radial pattern could also be used functionally, for example if the controller receives signals from an onboard compass or GPS system so that a line of lights leading from the center to the perimeter can be lit to indicate the north direction. Because cluster 134 is located near the front of the vehicle roof, near the driver, it can also be controlled to be automatically illuminated as a warning light, for example when one of the vehicle electronic control units detects a hazardous condition. In some embodiments, different colors can be selected to indicate different types of hazard conditions.

Lighting element 140 represents yet another type of light source. Lighting element 140 is shown centrally located in this illustrative embodiment, but it can be located in other locations on another panel, or another panel could have more than one lighting element of this type. Lighting element 140 can comprise a light conductor that receives light from a light source and illuminates a design such as a logo associated with the vehicle model, vehicle trim level, or vehicle manufacturer. Lighting element 140 can comprise one or more different types of light conductors suitable for use in the disclosed physical arrangement including, but not limited to, light pipes, etchings, prisms and channels.

With reference now to FIG. 2, panel 200 is a smaller less elongated laminated light-transmitting panel with embedded light sources. Again, the front of the vehicle is closer to the left edge of panel 200, and similar reference numbers indicate features that are similar to the features of panel 100 shown in FIG. 1. That is, lights 210 and 212 represent spotlights that generate a focused light beam when switched on. Panel 200 shows that additional spotlights 214 and 216 can be provided for other passengers sitting in another row of passenger seating. Lighting element 240 can comprise a light conductor similar to lighting element 140, or another type of light source. In some embodiments, because lighting element 240 is located above the driver's seating row, it can be an LCD, LED or OLED screen display used to deliver useful information to assist the driver.

Light cluster 236 is different from the light clusters provided in panel 100 in that the light sources are arranged in a grid pattern. In some embodiments, the light sources in light cluster 236 are controlled together with a single electrical circuit. In other embodiments, each light source can be independently controlled. In these embodiments, the electrical circuit is more intricate and a microprocessor with more computing power can be needed to control the independent lighting of each of the light sources in cluster 236. For a larger panel like the one shown in FIG. 1, predefined fixed patterns such as those shown in light clusters 130 and 132 can fulfill the desired purpose without being overly complex. A grid array over such a large surface as panel 100 is possible, although it can add to the cost and complexity of the panel. A smaller panel, such as panel 200 shown in FIG. 2, makes it more feasible to use a grid arranged as illustrated by light cluster 236 because the surface area is smaller. In an alternative embodiment, light cluster 236 can be replaced with an LCD, LED or OLED screen display.

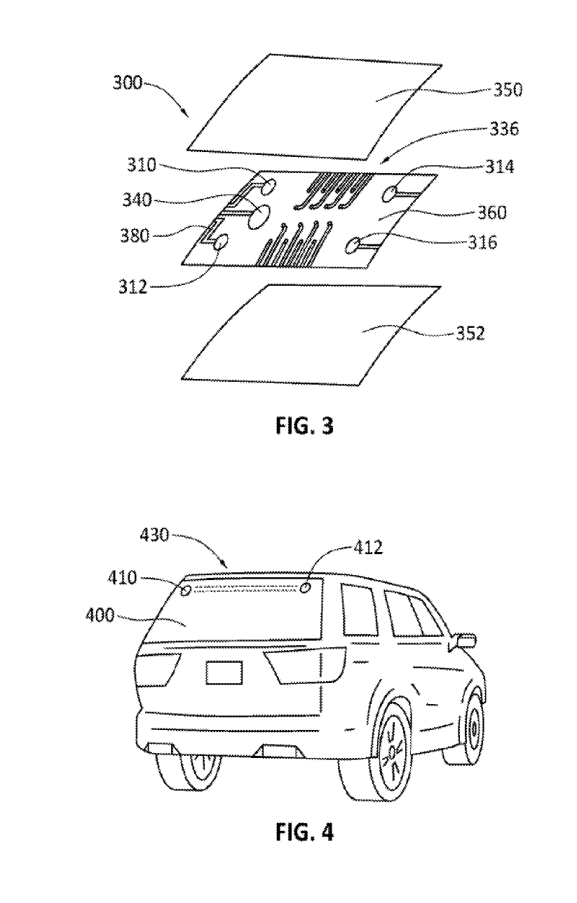

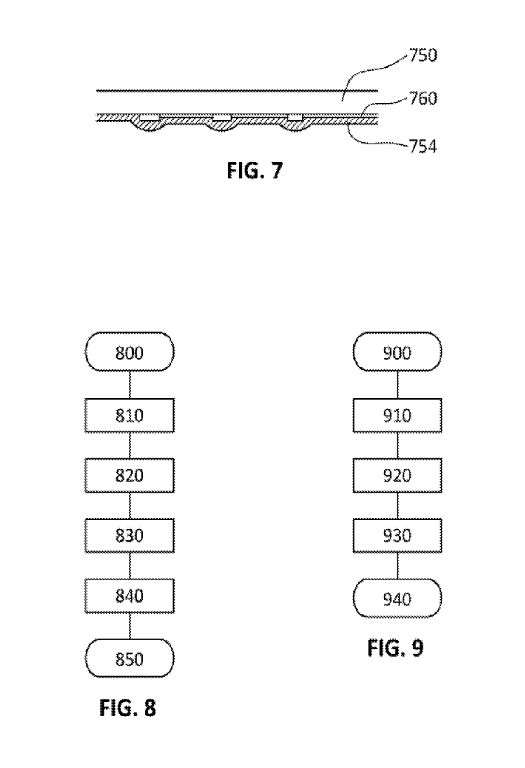

FIG. 3 shows an exploded view of laminated light-transmitting panel 300. First layer 350 is disposed opposite to second layer 352. In some embodiments, first layer 350 is a rigid transparent structural element that can be made from, among other things, glass, polycarbonate, plastic, laminated layers or combination of these or like materials. As with conventional laminated light-transmitting panels, each pair of adjacent rigid structural layers is bonded together by an interlayer. By way of example, typical material choices for interlayers include, among other things, polyvinyl butyral (“PVB”), ethylenevinyl acetate (“EVA”), EN, and polyethylenenapthalate (“PEN”). Material choice should be unrestricted, so long as the laminating process for use of such other interlayer materials does not subject the electrical circuits and light sources to damage by temperatures, pressures or chemicals associated with the interlayer material and associated laminating process. In the exploded view, third layer 360, comprises electrical circuits 380 for connecting each light source to power and ground. In some embodiments third layer 360 can be integrated with the interlayer. Third layer 360 shows light sources 310, 312, 314, and 316 which can be spotlights for generating a focused beam of light. Light cluster 336 is arranged in a grid with each light source having a separate electrical circuit. Like lighting element 140, lighting element 340 can illuminate a logo feature using light conducting elements or a screen display. When first and second layers are rigid structural elements, made for example from glass, plastic or polycarbonate structures, manufacturing methods similar to those taught by the '377 Patent can be employed. However, for automotive applications where weight is a factor and flexibility in the manufacturing process is desirable, second layer 352 can be the surface that faces the interior of the vehicle and it can be made from a lighter non-structural coating or thin film that seals and protects third layer 360, as shown in FIG. 7.

FIG. 7 is a cross section view of a laminated light transmitting panel with embedded lights where first layer 750 is a structural element on which third layer 760 is mounted. Third layer 760 is the layer which comprises the electrical circuits and the light sources connected to the electrical circuits. Separate electrical circuits are spaced apart but third layer 760 can also comprise electrically insulating material disposed between the electrical circuits, which can be especially helpful when the circuits are intricate and tightly spaced. Second layer 754 can be a coating or a thin film that is applied to seal and protect third layer 760. Glass windscreens and roof panels for vehicles are normally laminated panels because if these panels are subjected to impact, large and sharp broken pieces of glass could severely injure the vehicle occupants. Even when subjected to damaging impacts, instead of shattering and breaking into large sharp pieces, laminated glass cracks but is still held together by the interlayer that bonds the laminated layers of glass together. Accordingly, with the embodiment shown in FIG. 7, because first layer 750 is the only structural element, this layer itself can comprise laminated layers of glass, plastic, polycarbonate, or combinations thereof Side windows are not always laminated glass, and instead they can be made from tempered glass that is less expensive than laminated glass. If tempered glass is struck by an impact severe enough to break it, the vehicle occupants are still safe from serious injury because tempered glass shatters into small pieces (instead of large sharp shards).

Electrical circuits 380 can be conductive traces, for example, made from printed silver conductor, with light sources 310,312,314,316 and 340 connected to circuits 380 with electrically conductive adhesive. In some embodiments, the light sources are attached to a plastic substrate, such as a polyethylene terephthalate (“PET”) sheet or other transparent plastic film, known generally as a “flex circuits” or Flexible Printed Circuits (“FPC”). The FPC can be sandwiched between first layer 350 and second layer 352. Thermoplastic urethane (“TPU”) can be disposed within third layer 360 to fill voids between first layer 350 and second layer 352 created by the thickness of light sources 310, 312, 314, 316 and 340 and electrical circuits 380 within third layer 360.

With reference now to FIG. 4, a rear window of a vehicle is shown that can be made as an embodiment of the disclosed laminated light transmitting panel with embedded lighting elements. Panel 400 features at least one light cluster 430. In some embodiments, panel 400 is positioned where it does not obscure the driver's view to the rear, and/or where it can serve as the high central brake light. An advantage over conventional brake lights is that if polychromatic RGB LED's are employed the color of the lights can be changed so that light cluster 430 can be employed for other purposes. For example, if the vehicle is an emergency vehicle or a police car the color of the lights can be changed to blue and/or some combination of colors associated with the type of emergency vehicle. In addition to simplifying the lighting system and reducing the need to install additional lights, for unmarked law enforcement vehicles, multi-functional light cluster 430 also makes the character of the unmarked vehicle (as a law enforcement vehicle) less apparent, which can be advantageous in catching dangerous drivers who correct their unsafe driving habits when they spot a law enforcement vehicle, or when the vehicle is being used for surveillance and reducing the chance of detection is important. Panel 400 can also optionally include other lighting elements such as lights 410 and 412, which can be used, for example as additional tum signals, which could be useful for trucks, SUVs and other vehicles which are used to tow trailers or with other accessories that obscure the traditional tail lamps. With lights 410, 412 and light cluster 430, the purpose of the lights is to signal information to people external to the vehicle. To reduce distraction to the occupants of the vehicle, the layer that faces the interior can be opaque opposite to the light sources. That is, the interior-facing layer can be partially opaque around the light sources and clear so that the driver can see out elsewhere. Most vehicle windows have some level of tinting to reduce the glare from the sun, but for some vehicles, such as but not limited to SUV s and hatchbacks, it can be desirable for the rear window to be more darkly tinted or have a mirrored appearance for increased privacy, for security of storage areas. In these embodiments, panel 400 can be darkly tinted or have a mirrored finish.

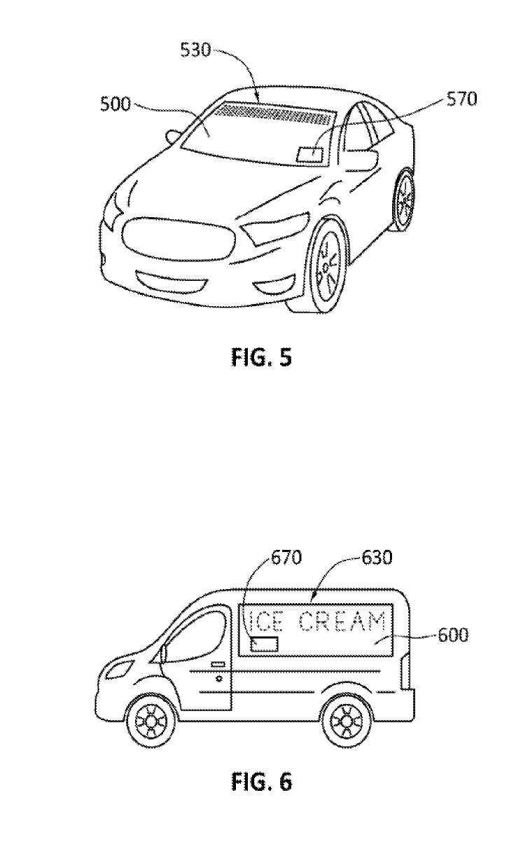

FIG. 5 shows the front windscreen of a vehicle which takes advantage of a laminated light-transmitting panel with embedded lighting elements. Panel 500 comprises light cluster 530 with borders at the top edge of panel 500. Lights located in this position can be useful for law enforcement vehicles and/or emergency vehicles. Not only is panel 500 more aerodynamic than external light bars, but like rear panel 400, it also makes unmarked law enforcement vehicles stealthier.

Civilian purposes for employing light panel 500 include, but are not limited to, off-road vehicles that might otherwise install auxiliary light bars that add to the height of the vehicle and cause higher fuel consumption by making the vehicle less aerodynamic. To avoid distraction to the driver, the portion of the layer opposite light cluster 530 that faces the vehicle interior can be made opaque so that lights in light cluster 530 cannot be seen, or are at least the visibility of the lights from light cluster 530 is reduced, from inside the vehicle. Light source 570 represents a screen display that can be embedded in panel 500. This screen is intended to be seen by the driver from inside the vehicle and by way of example, it can be a LCD, LED, OLED lit screen display that can be used to show useful information helpful to the driver. Light source 570 is an example where the layer of the panel that faces the outside can be obscured to prevent information on the screen display from being seen from outside the vehicle.

FIG. 6 is an example of a side window that uses a laminated light-transmitting panel with embedded lights. In the shown embodiment, panel 600 is a window on the side of a commercial truck and light cluster 630 is arranged in a manner that helps to advertise the wares of the truck operator, in this example ice cream. Panel 600 can also be equipped with screen display 670 that can be used to display a menu and pricing that is easily updated.

FIG. 8 is a process flow diagram showing steps in an example embodiment of a manufacturing process for a laminated light-transmitting panel with embedded lights for installation in a vehicle. In this embodiment, the first and second layers are both structural elements and the third layer which comprises the electrical circuits and light sources is part of pre-formed sheet that is integrated with an interlayer and electrically insulating material disposed between adjacent electrical circuits. After starting the process at 800, in manufacturing step 810 a first layer that is a light-transmitting structural element is formed and cleaned in preparation for lamination. In step 820 a second layer that is a light-transmitting structural element is formed and cleaned in preparation for lamination. In step 830 a third layer consisting of a preformed sheet comprising the electrical circuits, lighting elements, electrically insulating spacers between electrical circuits, and an interlayer material is positioned and laid between the first and second layers. The electrical circuits can be made from an electro-conductive material such as polyethylene terephthalate (“PET”). In some embodiments, this material choice is advantageously multi-functional, because this material is suitable both for use as an interlayer material and for electrical circuits. In step 840 the three layers are laminated together by processes associated with the type of interlayer material. Such laminating processes are known in the industry and can include passing the panel through rollers to apply pressure, subjecting the panel to a vacuum to remove air, and heating the panel to melt the interlayer sufficiently to bond the layers of the panel together. If the interlayer is of the type that requires thermosetting, materials that are set using relatively low temperature and low pressure are preferred to reduce the stress on the embedded electronic components. An example of a suitable thermosetting interlayer material is optical silicon. The final step in the lamination process can be heating the panel under pressure in an autoclave oven. Step 850 marks the end of the manufacturing process for this embodiment of the disclosed laminated light-transmitting panel with embedded light sources.

The above described embodiments can be used individually or in various suitable combinations. Listed steps can be excluded or additional steps added without departing from the scope of the present disclosure.

FIG. 9 is a process flow diagram showing steps in another embodiment of a manufacturing process for a laminated light-transmitting panel with embedded lights for installation in a vehicle. In this embodiment, only the first layer is a rigid structural element. The second layer faces the interior of the vehicle and is a coating or thin film that seals and protects the panel without being relied upon to contribute significant structural strength. A manufacturing step that precedes this process can be the manufacture of a laminated light-transmitting structural element, or a non-laminated tempered glass sheet, or a single layer polycarbonate or plastic sheet that becomes the first layer of the laminated panel. After starting the process at 900, in manufacturing step 910, a first layer that is a light-transmitting structural element is formed and cleaned in preparation for lamination. In step 920 a third layer, which can be a pre-formed sheet comprising the electrical circuits, lighting elements and electrically insulating spacers between electrical circuits is positioned and laid onto the first layer. The preformed sheet can optionally comprise an adhesive that holds the third layer in the desired position. Next, in step 930 a second layer, comprising a coating or thin film is applied onto the surface of the third layer. That is, the application of the second layer seals and protects the third layer to produce a structure like that shown in FIG. 7. While this results in a multi-layer structure, it is not “laminated” as would be understood by someone familiar with the laminating process employed for laminated glass, such as the lamination process described in relation to FIG. 8, but in the context of this disclosure, the process described in relation to FIG. 9 results in a laminated multi-layered structure in that all three layers are bonded together to form a unitary laminated structure. The end of the panel manufacturing process is indicated at 940. An advantage of using a thin film as the second layer is the ability to choose suitable bonding mechanisms for the manufacturing process that do not subject the light sources and electrical circuits to as high pressures or temperatures, as for the more conventional lamination process described with respect to FIG. 8. The same can be said for coatings, depending upon the type of coating and whether or not it requires thermosetting. That is, like with thin films, there is the ability with this process embodiment to select a coating that subjects the lighting layer to lower pressures and temperatures as compared to the lamination process described in relation to FIG. 8.

The above described embodiments can be used individually or in various suitable combinations. Listed steps can be excluded or additional steps added without departing from the scope of the present disclosure.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A laminated light-transmitting panel for installation in a vehicle comprising:
(a) a first layer, wherein said first layer is a light transmitting structural element;
(b) a second layer wherein said second layer is disposed opposite to said first layer; and
(c) a third layer disposed between said first and second layers, said third layer comprising:
(i) a plurality of light sources, wherein at least one of said plurality of light sources is an RGB light emitting diode that can be controlled independently from the other ones of said plurality of light sources; and
(ii) an electrical circuit connected to said plurality of light sources, said electrical circuit configured to control color and brightness of said RGB light emitting diode in accordance with an at least one predetermined setting to improve vehicle interior lighting for a passenger to assist with the alertness and comfort of said passenger.

2. The laminated light-transmitting panel of claim 1, wherein said electrical circuit automatically activates said RGB light emitting diode when said passenger enters or exits said vehicle.

3. The laminated light-transmitting panel of claim 1, wherein said electrical circuit automatically switches to a mode in which said RGB light emitting diode is activated with a predetermined color and brightness to act as a warning light when a vehicle electronic control unit detects a hazardous condition.

4. The laminated light-transmitting panel of claim 3 wherein different colors can be selected to indicate different types of hazard conditions.

5. The laminated light-transmitting panel of claim 1 further comprising:
(d) a transceiver that receives command signals from said passenger to control color and brightness of said RGB light emitting diode to change said predetermined settings to incorporate a personal preference.

6. The laminated light-transmitting panel of claim 1 wherein said second and said third layers can be installed in-situ using an adhesive to bond said second and third layers to said first layer.

7. The laminated light-transmitting panel of claim 6 wherein said second layer is an adhesive film that insulates and protects said third layer.

8. A laminated light-transmitting panel for installation in a vehicle comprises:
(a) a first layer, wherein said first layer is a light transmitting structural element;
(b) a second layer that is disposed opposite to said first layer; and
(c) a third layer disposed between said first and second layers, said third layer comprising:
(i) a plurality of light sources, wherein at least one of said plurality of light sources is an RGB light emitting diode that can be controlled independently from the other ones of said plurality of light sources; and
(ii) an electrical circuit connected to said plurality of light sources, said electrical circuit configured to control at least two of color, brightness, and flashing of said RGB light emitting diode.

9. The laminated light-transmitting panel of claim 8, wherein said RGB light emitting diode is part of a light cluster for external signaling, and said at least two functions comprises at least two of
(1) turn signal lighting,
(2) brake signal lighting,
(3) hazard lighting, and
(4) emergency vehicle lighting.

10. The laminated light-transmitting panel of claim 9 wherein said laminated light-transmitting panel is a window or roof panel and said second layer is the interior facing side of said laminated light-transmitting panel;
and wherein said laminated light-transmitting panel is opaque in areas adjacent to said RGB light emitting diode.

11. The laminated light-transmitting panel of claim 8, wherein said RGB light emitting diode is oriented to provide interior lighting and wherein said at least two functions comprise two of ambient lighting, entry lighting, exit lighting, hazard warning lighting and vehicle service warning lighting.

12. The laminated light-transmitting panel of claim 11 wherein said laminated light-transmitting panel is a window or roof panel and wherein said second layer is the exterior facing side of said laminated light-transmitting panel and is opaque in areas adjacent to said RGB light emitting diode.

13. A method of controlling an RGB light emitting diode light source that is embedded in a laminated light-transmitting panel that is installed in a vehicle, said method comprising:
(a) controlling brightness, color and dynamic timing, whereby said RGB light emitting diode light source is controllable to produce different effects for at least two different functional purposes.

14. The method of claim 13 wherein said light source provides light to a passenger cabin of said vehicle and said different functional purposes include:
(i) lighting a vehicle interior with colors and brightness to assist with passenger alertness and comfort; and
(ii) indicating a hazard condition.

15. The method of claim 13 wherein said light source is an exterior light source and said different functional purposes include at least two of:
(i) emergency vehicle lighting;
(ii) hazard lighting;
(iii) turn signal lighting; and
(iv) brake lighting.

16. The method of claim 13 further comprising:
(b) automatically activating said RGB light emitting diode light source to produce a predetermined lighting effect when a vehicle electronic control unit detects a condition associated with said predetermined lighting effect.
